(19) United States
(12) Patent Application Publication
(10) Pub. No.: US 2012/0020727 A1
(43) Pub. Date: Jan. 26, 2012

(54) LOCKING PLATE SYSTEM

(76) Inventor: Briane Lee Hartley, Imperial, PA (US)

(21) Appl. No.: 13/187,932

(22) Filed: Jul. 21, 2011

Related U.S. Application Data
(60) Provisional application No. 61/366,251, filed on Jul. 21, 2010.

(51) Int. Cl. F16B 5/00

(52) U.S. Cl. 403/404

(57) ABSTRACT

A locking plate system comprising a locking plate assembly and proprietary wrench is disclosed. In a first embodiment, the locking plate assembly is installed either singularly or in sets on a rigid panel (rectangular or L-shaped) and used to secure the panel to an elevator wall or door jam. In addition, rivets are used to secure the locking plate assembly, The locking plate assembly utilizes a jack post and a latch dog, each having teeth that are manipulated to lock and unlock the system. The respective angles of the interfacing teeth on both the jack post and latch dog provide the unique capability of the locking system to effectuate both the functional compressive strength of the locking plate and the ability of the mechanism to retain its locking functionality. In other embodiments, the rigid panels are included in the embodiment, with specific description given for the composition of the panels.

### CROSS-REFERENCE TO RELATED APPLICATION(S)

The present application may include subject matter related to one or more of the following commonly-owned United States patent applications, each of which was filed on even date herewith, claims the benefit of, and is hereby incorporated herein by reference in its entirety: U.S. Provisional Application No. 61/366,251, filed Jul. 21, 2010.

### TECHNICAL FIELD

This invention relates to a locking plate system that when attached to a surface of a rigid structure applies a compressive force parallel to the surface of the rigid structure.

### BACKGROUND

Elevators, while constructed in a manner that ensures security of its occupants, often have decorative features included in the walls and door jams that appeal to a clientele that use the elevator. However, the elevator often performs a dual usage. In addition to transporting passengers, it may on occasion be used for moving large pieces of equipment such as office equipment, furniture, and building maintenance items, and also used by service carts, such as water bottle carts, mail package and coffee/snack carts. Furthermore, there is risk during the moving of equipment that the equipment may damage the elevator and its decorative items. Therefore, there is a need to have a means for adding protective panels to the elevator walls and door jams when equipment is being moved, and removing the protective panels when the elevator is restored for passenger use. Current means for protecting wall and door jams use a protective panel to cover the elevator surfaces and decorative elevator elements, and a means for attaching a protective panel to the elevator surfaces.

However, existing protective products are either too heavy to be truly portable, are inflatable and therefore subject to puncture, do not have adequate means to safely secure them to the interior walls or door jambs or have a securing mechanism which must be left permanently attached to the interior walls or door jamb thereby leaving unsightly parts remaining on the decorative trim surface. Furthermore, such existing protective products may be vulnerable to tampering by unauthorized persons.

More generally, there is a need for a locking plate system that, when attached to a surface of a rigid structure, applies a compressive force parallel to the surface of the rigid structure. Such a locking plate system may be used for installing a rigid panel that partitions a room or other space into two chambers, or installing a vertical post that supports a sagging ceiling beam.

### SUMMARY

The locking plate system is comprised of eight members of a locking plate assembly held together with four rivets, and a proprietary wrench. The locking plate assembly utilizes a jack post and a latch dog, each having teeth that intermesh and may be manipulated to lock and unlock the system. The respective angles of the interfacing teeth on both the jack post and the latch dog provide the unique capability of the locking system to effectuate both the functional compressive strength of the locking plate and the ability of the mechanism to retain its locking functionality. The jack post also has a set of oval cavities that are used to apply leverage to the system using the proprietary wrench. The mechanism allows the jack post to move freely when the latch dog is in the unlocked position (teeth are not engaged). The proprietary wrench is employed by simultaneously placing its two pins into one of the jack post oval cavities and one of the two fulcrum holes respectively. Compressive strength is achieved by ratcheting the jack post in the direction of a structure having opposing rigid surfaces. When the latch dog is in the locked position the jack post can only move in an extended direction against the opposing rigid surfaces. When sufficient compression is reached to hold the protective panel in place the latch dog is moved to the locked position that retains the compressive strength and the proprietary wrench may then be removed.

In a first application of the current invention, the locking plate system is installed singly, or in pairs, on a rigid panel and used to secure the panel to the elevator. The panels, locked into place with a compression fit mechanism included in the locking plate assembly, is designed to ensure fast, secure, functional, low profile protection. The locking plate system includes a proprietary wrench designed to lock and unlock the mechanism while preventing the locking system to be manipulated by unauthorized users.

The inventive concept may be applied to other fixed structures, enclosed areas, or other properties of value to protect them from damage, or when required to spread apart two rigid structures.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

The invention description below refers to the accompanying drawings, of which:

FIG. 1 illustrates a perspective view of a first embodiment of the present invention.

FIG. 2 illustrates a partially exploded view of the locking plate assembly.

FIG. 3 illustrates the members of the locking plate assembly.

FIG. 4A illustrates a perspective view of the assembled locking plate assembly of the current invention.

FIG. 4B illustrates a perspective view of the proprietary wrench of the current invention.

FIGS. SA and SB illustrate how the proprietary wrench is used to force the footer of the jack post towards and away from a wall.

FIG. 6A presents a perspective view of the locking plate assembly illustrating its dimensions for a first embodiment.

FIG. 6B presents a perspective view of the first and second side rails and latch post illustrating the dimensions for a first embodiment.

FIG. 6C presents a perspective view of the proprietary wrench illustrating the dimensions for the first embodiment.

FIG. 6D presents a frontal detail view of the locking mechanism, the detail indicated in FIG. 2.

FIG. 6E illustrates a close up detail of FIG. 6D, in expanded scale, illustrating a design of the intermeshing teeth.

FIGS. 7A and 7B illustrate the locking plate assembly used in the interior walls and exterior wall jamb of an elevator.

FIGS. 8A and 8B illustrate the locking plate assembly used to support a partition and to hold up a beam respectively.

### DETAILED DESCRIPTION

In the detailed specification, if more than one part is included in a figure, only one or two parts may have a numeral associated with it. The same numeral may be used to refer to identical parts in different members. Terms such as top, bottom, left, right. front, rear and back refer to the figure being referenced.

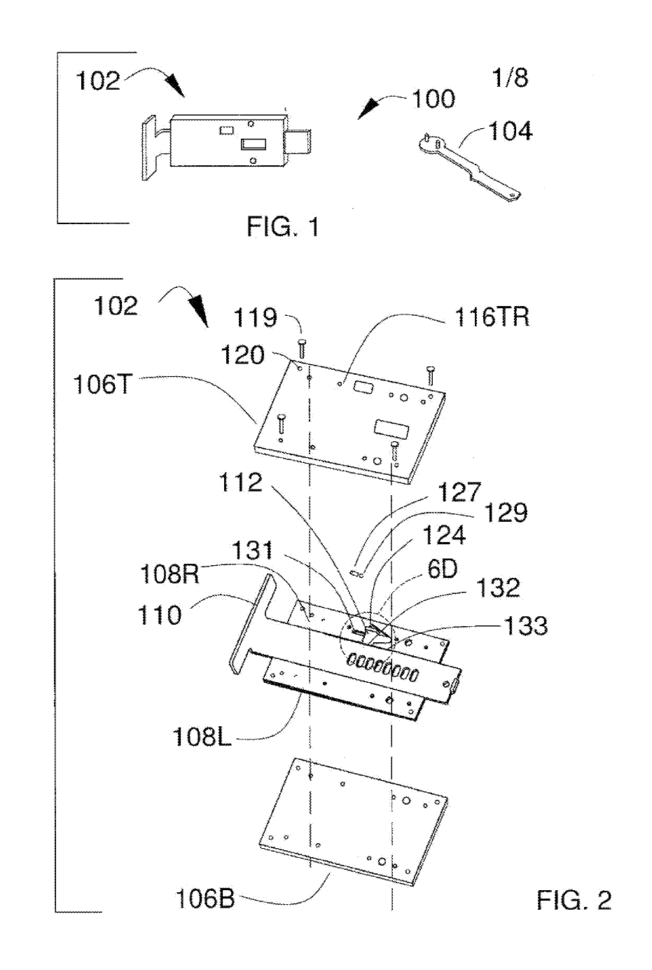

FIG. 1 shows a first embodiment 100 of the present invention. First embodiment 100 is comprised of a locking plate assembly 102, and a proprietary wrench 104.

FIG. 2 illustrates a partially exploded perspective view of locking plate assembly 102 of first embodiment 100. Referring to FIGS. 1 and 2, locking plate assembly 102 is comprised of eight members: a top plate 106T, a bottom plate 106B, a first side rail 108R, a second side rail 10SL, a jack post 110, a latch dog 112, a compressible rubber plug 127 and a ball bearing 129. Also included are four rivets 119. When locking plate assembly 102 is assembled, top plate 106T and bottom plate 106B sandwich the first side rail 108R, second side rail 108L, and the jack post 110. Top plate 106T, bottom plate 106B, and jack post 110 having jack post teeth 133, are positioned in the same plane as first side rail 108R and second side rail 108L, with jack post 110 positioned between first side rail 108R and second side rail 108L. First side rail 108R has a latch dog containment cavity 114 that contains latch dog 112, but allows latch dog 112 to rotate a small amount within the plane containing first side rail 108R and second side rail 108L. Latch dog containment cavity 114 has a channel 131 that accommodates compressible rubber plug 127 and ball bearing 129. Latch dog 112 has a latch dog tab 124 and latch dog teeth 132. Locking plate assembly 102 is assembled using the four rivets 119. Rivet receiving holes 120, four located on top plate 106T, four located on bottom plate 106B, two located on first side rail 108R and two located on second side rail 108L secure the locking plate assembly 102 members.

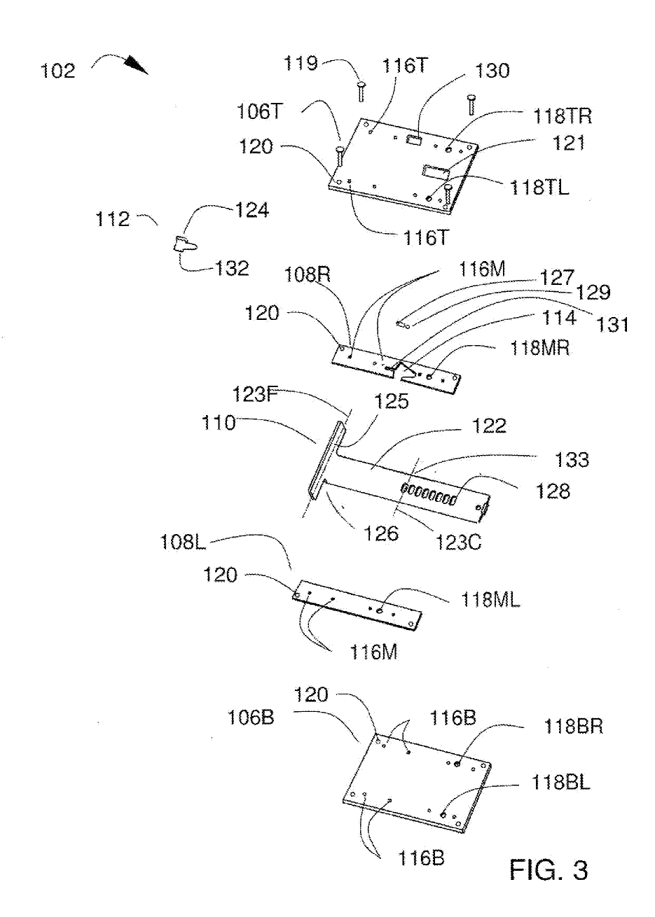

FIG. 3 illustrates the members of locking plate assembly 102. Referring to FIGS. 2 and 3, top plate 106T has eight top fastener holes 116T. First side rail 108R has four middle fastener holes 116M, and second side rail 108L, has four middle fastener holes 116M. Bottom plate 106B has eight bottom fastener holes 116B. When locking plate assembly 102 is assembled, these fastener holes are aligned so that fasteners, such as bolts or screws, may secure locking plate assembly 102 in the assembled configuration to a rigid panel 138 using an attachment means, such as screws or bolts. The attachment means are not shown in FIG. 3. Alternatively, locking plate assembly 102 may be attached to rigid panel 138 using adhesives.

Referring again to FIGS. 2 and 3, top plate 106T has a top right fulcrum hole 118TR, a top left fulcrum hole 118TL, and a pin accepting cavity 121 having an approximately rectangular shape. Bottom plate 106B has a bottom right fulcrum hole 118BR and a bottom left fulcrum hole 118BL. Jack post 110 has a leg 122, and a footer 125 positioned on a first leg end 126 of leg 122. Jack post 110 has an array of equally spaced set of oval cavities 128 positioned on leg 122 with oval cavity major axis 123C of each of the oval cavities 128 lying parallel to footer major axis 123F of footer 125. Top plate 106T has a tab access cavity 130. Tab access cavity 130, latch dog containment cavity 114, and latch dog 112 are dimensioned and configured so that latch dog 112 fits in tab access cavity 130 with latch dog tab 124 of latch dog 112 protruding from tab access cavity 130.

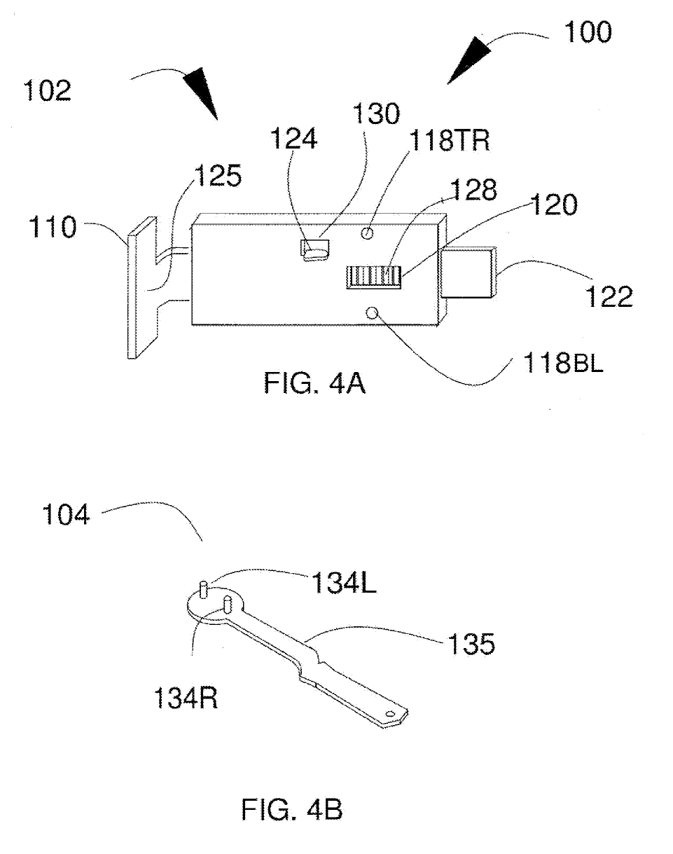

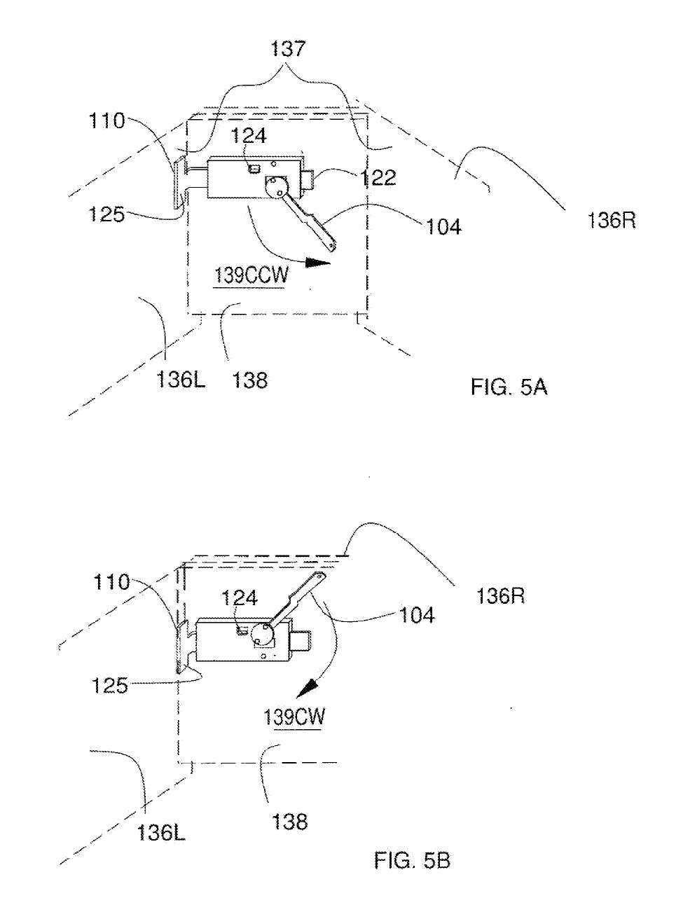

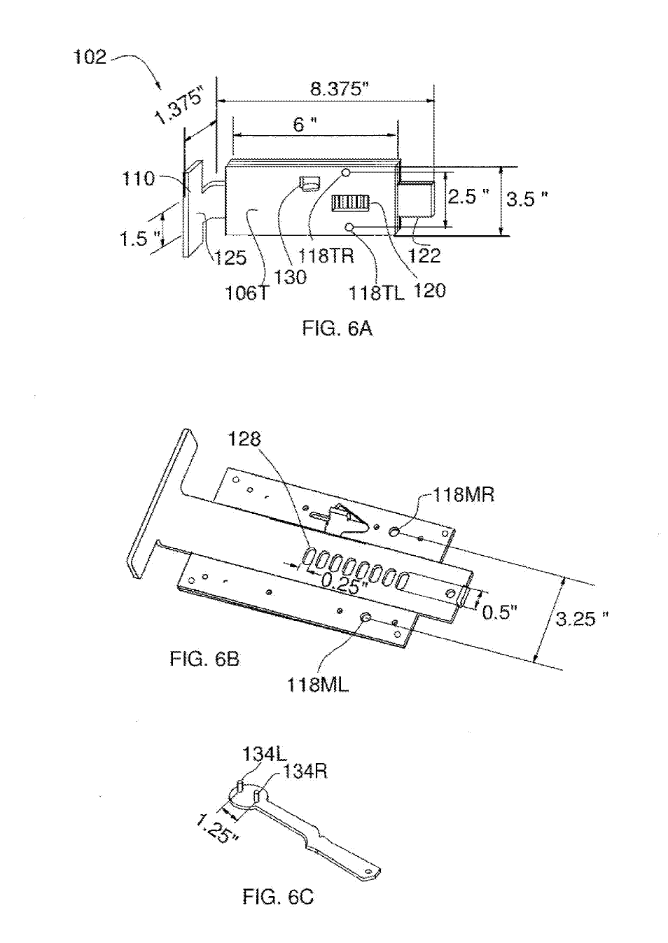

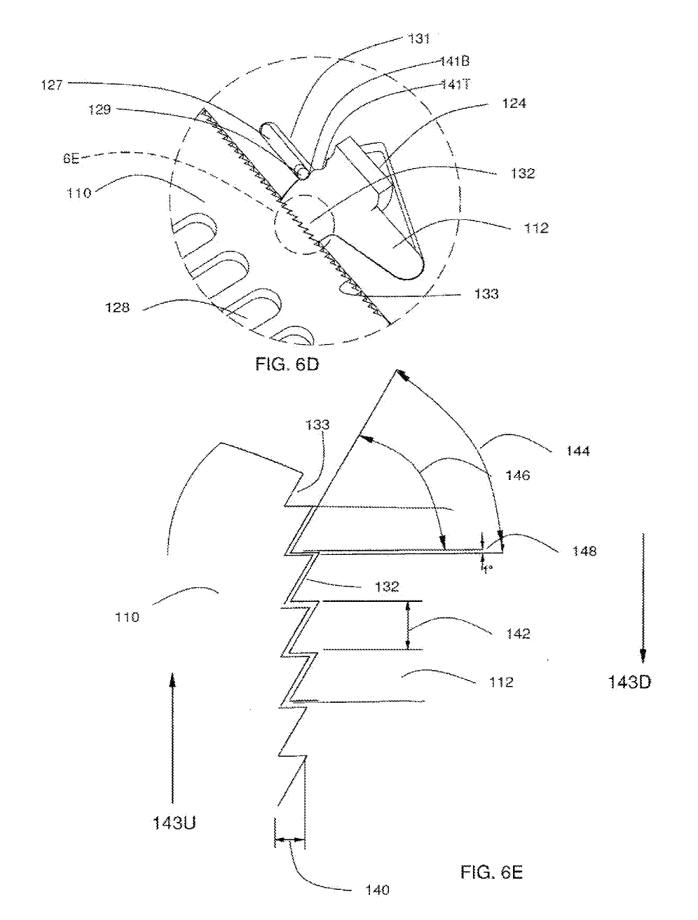

FIG. 4A illustrates a perspective view of locking plate assembly 102 assembled for use with proprietary wrench 104. FIG. 4B illustrates a perspective view of proprietary wrench 104. Proprietary wrench 104 has a first pin 134L, a second pin 134R, and a handle 135. FIG. 5A illustrates locking plate assembly 102 attached to a rigid panel 138. FIG. 6D illustrates a detail of latch dog 112 positioned in latch dog containment cavity 114 with compressible rubber plug 127 and ball bearing 129 positioned in channel 131. Latch dog 112 has two dimples 141 that accommodate the ball bearing 129.

Referring to FIGS. 5A, 5B, and 6D, rigid panel 138 is installed in a structure having opposing rigid surfaces 137 comprising left rigid structure 136L, and right rigid structure 136R. Referring to FIGS. 4A, 4B and 5A, proprietary wrench 104 is used to force the footer 125 of jack post 110 against left rigid structure 1361. This is accomplished by:

Step A: Manually push the jack post 110 as far left as possible, and simultaneously engage the latch dog teeth 132 with jack post teeth 133 by pushing the latch dog tab 124 towards jack post 110. Compressible rubber plug 127 pushes ball bearing 129 so that it engages bottom dimple 141B and holds the latch dog 112 in place, keeping the teeth engaged.

Step B: Insert the first pin 1341. into oval cavity 128 and simultaneously insert the second pin 134R in bottom left fulcrum hole 118BL. Then rotate proprietary wrench 104 in a counter clockwise direction 139CCW as far as possible. The latch dog teeth 132 continue to engage the jack post teeth 133 since compressible rubber plug 127 continues to hold the ball bearing 129 against bottom dimple 141 B and holds the latch dog 112 in place, thereby keeping the teeth engaged.

Step C: Remove proprietary wrench 104 from locking plate assembly 102. Repeat step B and C until rigid panel 138 is secured.

FIGS. 4-A, 4B, and 513 illustrate how proprietary wrench 104 is used to disengage the footer 125 of jack post 110 from left rigid structure 136L of the opposing rigid surfaces 137. This is accomplished by:

Step A: Insert first pin the into oval cavity 128 and simultaneously insert the second pin 134R in bottom left fulcrum hole 118BL. Then rotate proprietary wrench 104 in a counter clockwise direction 139CCW as far as possible, and simultaneously disengage the latch dog teeth 132 with jack post teeth 133 by pushing the latch dog tab 124 away from the jack post 110. Compressible rubber plug 127 pushes ball bearing 129 so that it engages the top dimple 141T and holds the latch dog 112 in place, keeping the teeth disengaged.

Step B: Manually push the jack post 110 as far right as possible, while simultaneously disengaging the latch dog teeth 132 with jack post teeth 133 by pushing the latch dog tab 124 away from jack post 110 until rigid panel 138 is released.

FIGS. 6A, 6B, 6C, 6D, and 6E illustrate preferred dimensions of the first embodiment 100 members when applied to panels such as those installed in elevator interiors and elevator exterior door jambs. Referring to FIG. 6A, top plate 106T has a length of 6.0 inches (15.24 cm) and a height of 3½ inches (8.89 cm). Jack post 110 has a horizontal length of 8⅜ inches (21.27 cm) and a foot depth of 1⅜ inches (3.492 cm). Oval cavities 128 have a length of a ½ inch (1.27 cm) and a diameter of ¼ inch (0.635 cm). Top left fulcrum hole 118TL and top right fulcrum hole 118TR are separated by a distance of 3½ inches (8.89 cm) between centers, and each has a diameter of 0.26 inches (0.6604 cm). The remaining members, the first side rails 108R and second side rail 108L and latch dog 112 (not shown in FIG. 6A, see FIG. 2) are dimensioned and configured to be consistent with these dimensions.

FIG. 6B illustrates first side rail 108R, second side rail 108L and jack post 110. FIG. 6C illustrates dimensions of the proprietary wrench of first embodiment 100 of the invention. Referring to FIGS. 6B and 6C, first pin 124L and second pin 124R are separated by a distance of 1¼ inches (3.175 cm) between pin centers; each pin having a diameter of slightly less than ¼ inch (0.635 cm).

FIG. 6D, a close up detail view as indicated in FIG. 2, illustrates how jack post 110, latch dog containment cavity 114, and latch dog 112 operationally interact, and provides dimensions for a first embodiment. Latch dog containment cavity 114 and latch dog 112 are sized and configured so latch dog 112 can rotate several degrees within latch dog containment cavity 114. Latch dog tab 124, which protrudes from tab access cavity 130 located on top plate 106T, is used to move latch dog 112 towards or away from jack post 110, so that latch dog 112 fits in tab access cavity 130 with latch dog tab 124 of latch dog 112 protruding from tab access cavity 130. Latch dog containment cavity 114 and latch dog 112 are dimensioned and configured so that latch dog 112 fits loosely in tab access cavity 130. Latch dog tab 124 of latch dog 112 protrudes from tab access cavity 130. (Tab access cavity 130 is not shown in FIG. 6D). Latch dog 112 is positioned in latch dog containment cavity 114 with compressible rubber plug 127 and ball bearing 129 being positioned in channel 131. Latch dog 112 has two dimples 141 that accommodate the ball bearing 129. When latch dog 112 is rotated so that the latch dog teeth 132 engage jack post teeth 133, latch dog teeth 132 and jack post teeth 133 may lock if there are opposing forces on latch dog teeth 132 and jack post teeth 133.

FIG. 6E illustrates a design for a detail of FIG. 6D in expanded scale. The design of FIG. 6E shows the dimension of latch dog teeth 132 and jack post teeth 133 so that the teeth engage and disengage properly. The teeth will lock provided opposing forces with a first force 143D on latch dog 112 and a second force 143U on jack post 110. Jack post teeth 133 and latch dog teeth 132 each have a tooth height 140 of 0.362 inches (0.9195 cm), and a tooth width 142 of 0.62 inches (1.575 cm). Jack post teeth 133 have a jack post tooth angle 144 of sixty degrees from horizontal, and latch dog teeth 132 have a latch dog tooth angle 146 of fifty nine degrees, leaving an angle difference 148 of one degree.

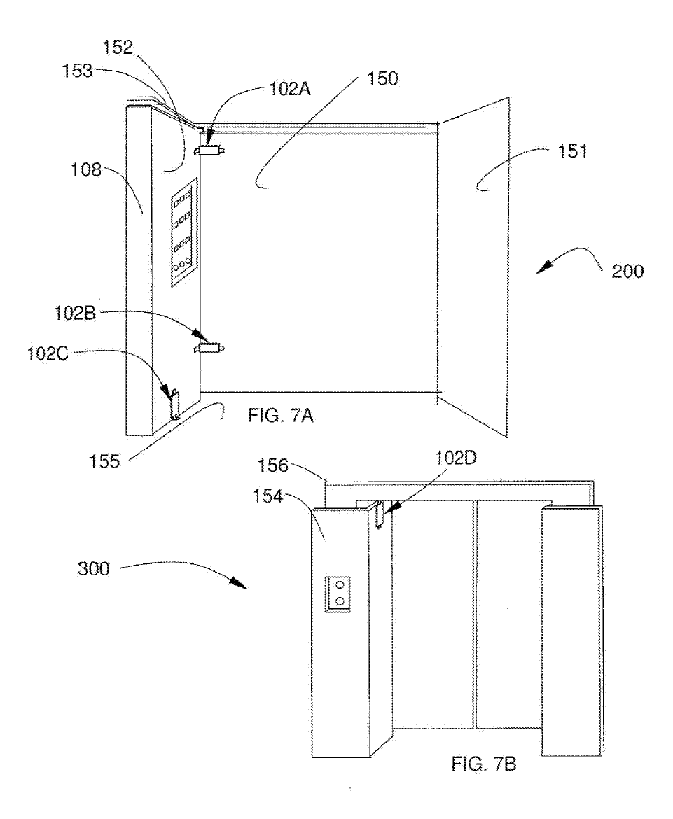

FIGS. 7A and 7B illustrate the first embodiment 100 of the present locking plate invention when used with an elevator. Referring to FIG. 7A, first locking plate assembly 102A and second locking plate assembly 102B, are attached to a rear rigid panel 150 located in the interior of an elevator cab, are positioned horizontally, and provide a compression force on left rigid panel 152 and right rigid panel 151 positioned on the interior walls of an elevator. Third locking plate assembly 102C, attached to left rigid panel 152 of the interior elevator, is positioned vertically and applies a compressive force to elevator floor 155 and interior door header 153. The first embodiment 100, together with one or more rigid panels is a second embodiment 200 of the current invention.

Referring to FIG. 7B, first embodiment 100 includes a fourth locking plate assembly 102D that secure an L-shaped rigid panel 154 installed on door jamb 156. Fourth locking plate assembly 10213 is positioned vertically, is attached to the L-shaped rigid panel 154, protects door jamb 156, and applies a compressive force to the elevator entrance floor and the elevator exterior door header. The rear rigid panel 150, right rigid panel 151, left rigid panel 152, and L-shaped rigid panel 154 are included in a second embodiment 200 of the current invention. The first embodiment 100, together with the L-shaped rigid panel 154 comprises a third embodiment 300 of the current invention.

Referring to FIGS. 7A and 7B, the left rigid panel 152, rear rigid panels 150 and right rigid panel 151 preferably have an inner core of compressible plastic foam material, such as closed cell polyethylene, closed cell polystyrene or a combination of closed cell polyethylene-polystyrene foam. This foam core may or may not be provided, as desired, with an outer resilient plastic skin.

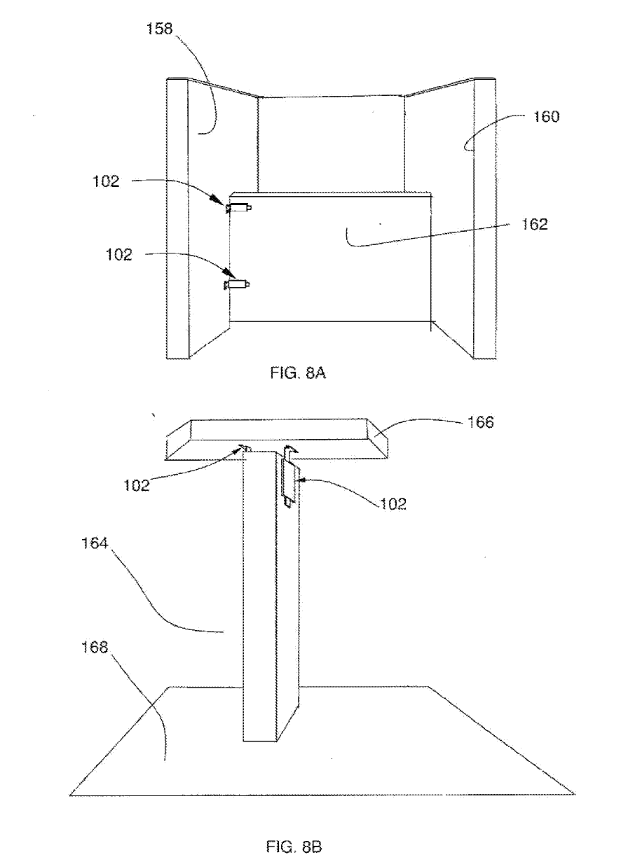

FIG. 8A illustrates the use of locking plate assembly 102 to support a partition 162 used to separate left wall 158 and right wall 160 of a room into two chambers. FIG. 8B illustrates the use of two locking plate assemblies 102 in conjunction with a post 164 resting on floor 168 to support a beam 166. The two locking plate assemblies 102 used in FIG. 8B may have dimensions much larger than the dimensions illustrated in FIGS. 7A and 6C, with corresponding larger dimensions of the proprietary wrench, since it is designed to handle a heavier load.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A locking plate system for securing a rigid panel to a structure having opposing rigid surfaces, the locking plate system comprising:
a locking plate assembly; and
a proprietary wrench, wherein when one or more of the locking plate assemblies are securely attached to a rigid panel, such that the rigid panel may be removably attached to the opposing rigid surfaces using the proprietary wrench.

2. The locking plate system of claim 1 further comprising at least one rigid panel.

3. The locking plate system of claim 1 wherein the rigid panel includes an inner compressible plastic foam core.

4. The locking plate system of claim 3 wherein the inner compressible plastic foam core is selected from the group consisting of: closed cell polyethylene, closed cell polystyrene, and a combination of closed cell polyethylene and closed cell polystyrene.

5. The locking plate system of claim 3 wherein the inner compressible plastic foam is further comprised of an outer resilient plastic skin.

6. A locking plate system for securing at least one rigid panel to the interior of an elevator having opposing rigid surfaces, the locking plate system comprising;
a locking plate assembly; and
a proprietary wrench, wherein when one or more of the locking plate assemblies are securely attached to a rigid panel, such that the rigid panel may be removably attached to the opposing rigid surfaces using the proprietary wrench.

7. The locking plate system of claim 6 wherein the rigid panel includes an inner compressible plastic foam core.

8. The locking plate system of claim 7 wherein the inner compressible plastic foam core is selected from the group consisting of: closed cell polyethylene, closed cell polystyrene, and a combination of closed cell polyethylene and closed cell polystyrene.

9. The locking plate system of claim 7 wherein the inner compressible plastic foam is further comprised of an outer resilient plastic skin.

10. A locking plate system for securing at least one L-shaped rigid panel to a door jamb of an elevator, the locking plate system comprising:
a locking plate assembly, and
a proprietary wrench, wherein the locking plate assembly is securely attached to the L-shaped rigid panel, and wherein the L-shaped rigid panel may be removably attached to the door jamb using the proprietary wrench.

11. The locking plate system of claim 10 wherein the L-shaped rigid panel includes an inner compressible plastic foam core.

12. The locking plate system of claim 11 wherein the inner compressible plastic foam core is selected from the group consisting of: closed cell polyethylene, closed cell polystyrene, and a combination of closed cell polyethylene and closed cell polystyrene.

13. The locking plate system of claim 11 wherein the inner compressible plastic foam is further comprised of an outer resilient plastic skin.
